(19) United States
(12) Patent Application Publication
(10) Pub. No.: US 2024/0273862 A1
(43) Pub. Date: Aug. 15, 2024

(54) Method and System for Verification of Persons in Portrait Paintings

(71) Applicant: Fraunhofer Gesellschaft zur Förderung der angewandten Forschung e.V., München (DE)

(72) Inventors: Philipp Terhörst, Darmstadt (DE); Marco Huber, Darmstadt (DE); Naser Damer, Darmstadt (DE)

(21) Appl. No.: 18/648,680

(22) Filed: Apr. 29, 2024

Related U.S. Application Data
(63) Continuation of application No. PCT/EP2022/079450, filed on Oct. 21, 2022.

(30) Foreign Application Priority Data
Oct. 29, 2021 (EP) 21205625.3

(51) Int. Cl. G06V 10/74; G06V 10/40; G06V 10/75; G06V 10/774; G06V 10/82; G06V 40/10

(52) U.S. Cl. CPC G06V 10/761; G06V 10/40; G06V 10/751; G06V 10/774; G06V 10/82; G06V 40/10

(57) ABSTRACT

A method for verification of persons in portrait paintings. The method includes providing a reference image set including images of a reference person. The method includes providing a contrary image set including images of a contrary person. The method includes providing at least one image of a portrait painting to be examined. The portrait painting depicts a person to be verified. The method includes determining a distribution of similarities by using features of the images from the reference and/or the contrary image set. The method includes determining a degree of similarity by using the features of the image to be examined and each image from the reference image set. The method includes verifying whether the person to be verified is identical to the reference person when the degree of similarity meets a criterion.

### CROSS-REFERENCE TO RELATED APPLICATIONS

This application is a Continuation of International Application No. PCT/EP2022/079450 filed Oct. 21, 2022, which claims priority to European Application No. 21205625.3 filed Oct. 29, 2021. The entire disclosures of which are incorporated by reference.

### FIELD

The present disclosure relates to a method and a system for the verification of persons in portrait paintings.

### BACKGROUND

The invention relates to a method and a system for the verification of persons in portrait paintings, as well as a computer program product.

A portrait usually depicts a person, particularly the face or the head of a person. A portrait may be represented by a painting or a photography. Also known are portraits in the form of busts, sculptures, masks, or mosaics.

Accordingly, a portrait painting may refer to a painting showing the portrait of a person in the form of a painted or drawn painting. Here, the portrait painting generally includes a section showing the face or the head of the depicted person.

Particularly, historic portrait paintings depict important persons of an epoch and also allow for conclusions about the life of historically important persons. Partly due to advancements in the painting techniques, numerous portrait paintings originate from the times of the renaissance. Here, the persons depicted in historic portrait paintings were generally so relevant that a plurality of portrait paintings of a person were produced. For example, a plurality of portrait paintings of a person was produced because a person was depicted in portrait paintings at different times in his/her life. Of course, a person may also have been depicted by various painters. It is also feasible that a person was depicted in a plurality of portrait paintings from various perspectives.

For a large number of such historic portrait paintings, however, it is not conveyed which person is depicted in a portrait painting, particularly because this information may have been lost in the course of time.

Traditionally, an assumption relating to the identity of the depicted person is made for establishing which person is depicted in a historic portrait painting. Such an assumption may particularly be based on the statement of an art expert or art historian. For example, the expert or historian may use a portrait painting for which the person depicted therein is verified for the formation of an opinion and will then compare this with the portrait painting in question to arrive at a statement regarding the identity of the depicted person.

This, however, adversely results in that such an assumption or statement is always of a subjective nature, and that seeking expert advice generally involves high costs and expenditure of time.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Therefore, the technical problem arises to provide a method and a system for the verification of persons in portrait paintings as well as a computer program product which verifies the identity of a depicted person with high reliability and accuracy.

The solution to the technical problem emerges from the subject matters having the features of the independent claims. Other advantageous implementations of the invention emerge from the sub-claims.

A basic idea of the invention is the verification of the identity of a person in a portrait painting to be examined. To this end, the invention provides for the determination of a technical criterion serving to objectively distinguish the reference person from a contrary person with the aid of images of a plurality of portrait paintings of a reference person and images of a plurality of portrait paintings of one or a plurality of contrary person(s) other than the reference person using a method of machine learning. In this way, a method for the verification of persons not involving the disadvantages mentioned above is rendered possible, it being verified whether or not the person depicted in a portrait painting to be examined is identical to the reference person.

Therefore, what is proposed is a method for the verification of persons in portrait paintings comprising:
providing for a reference image set including images of at least two, particularly different portrait paintings, the portrait paintings depicting the same reference person,
providing for a contrary image set including images of at least two other portrait paintings, the other portrait paintings respectively depicting a contrary person,
providing for at least one image of a portrait painting to be examined, the portrait painting depicting a person to be verified,
determining image-specific features by using a method of machine learning, at least one feature being allocated to each image,
determining a first distribution of similarities by using or depending on the features of such images from the reference and/or contrary image set depicting the same person,
determining another distribution of similarities by using or depending on the features of such images from the reference image and/or contrary image set depicting different persons,
determining at least one parameter required for evaluating a criterion for distinguishing the reference person from the contrary person(s) depending on the first and/or the other distribution of similarities,
determining a degree of similarity by using or depending on the features of the image to be examined and each image of the reference image set,
verifying whether the person to be verified is identical to the reference person when the degree of similarity meets the criterion.

An image refers to an image section of a portrait painting showing at least part of the face of the person depicted in the portrait painting. However, the image section may also comprise the entire portrait painting or also a surrounding of the portrait painting. The image may be encoded in the form an image file available, for example, as a RAW, JPEG, or PNG file. In particular, an image may be generated by using an imaging system by reproducing a portrait painting or a section of the portrait painting by using an imaging system.

An image-specific feature or image-specific features may be established as a vector. The features established in the form of a vector are generally not intuitively or directly interpretable by a human user.

The images of the reference image set differ at least in that at least one image of the reference image set reproduces the first of the at least two portrait paintings, and another image reproduces the second of the at least two portrait paintings. Of course, the reference image set may comprise more than two images even if these images only represent one of two portrait paintings, respectively. For example, a portrait painting may be represented by a plurality of images, for example, from different angles of view, and these images may then be part of the reference image set.

The reference person is a, usually, historically relevant person the identity of whom is conveyed, i.e., previously known. The identity of a person may be conveyed or previously known, for example, by a title of a portrait painting naming the identity of the depicted person. Here, all images of the reference image set are images of portrait paintings depicting the same reference person. At least two portrait paintings, however, four or more portrait paintings of the reference person exist. The more portrait paintings of the reference person the reference image set comprises, the better is the reliability of the proposed method. Due to the fact that at least two images of the at least two different portrait paintings of the reference person are provided, various properties such as, for example, different perspectives of the representation of the reference person by a portrait painting can be taken into consideration so that the parameter for the evaluation of a criterion for distinguishing the reference person from the contrary person can be determined with a higher accuracy. A negative influence of inaccuracies which occurred, e.g., when the portrait was painted (e.g., painting with incorrect dimensions or proportions and/or with distortions) on the reliability of the proposed method can also be advantageously reduced.

A contrary person is another, usually likewise historically relevant person the identity of whom is conveyed or previously known. Here, the contrary image set comprises at least two different images of portrait paintings of the same contrary person, of a plurality of different contrary persons. Different contrary persons are persons the identity of whom is different from each other. Here, it is also important that the contrary person(s) is/are different from the reference person, i.e., that the reference and the contrary person(s) are different persons or have different identities. At least two portrait paintings, however, three or more portrait paintings, particularly three to five portrait paintings exist of each contrary person. For different contrary persons, also different numbers of portrait paintings may exist. For one contrary person, e.g., 100 or more portrait paintings may exist while, for another contrary person, fewer portrait paintings exist. The contrary image set further comprises images of at least two different contrary persons.

The image to be examined refers to a portrait painting depicting a person the identity of whom is not conveyed, i.e., unknown. Such a person may also be a historically relevant person. The objective of the method described here is to verify whether or not this unknown person is identical to the reference person.

The portrait paintings or images of the contrary image set are selected so that they are similar to the portrait paintings of the reference image set with regard to the used painting style or the used painting technique. For example, by the portrait painting being produced by the same painter or in the same or a similar epoch. The gender, the age, or another person-specific property of the reference person may also be taken into consideration in the selection of the portrait paintings or images of the contrary image set. Particularly, a selection criterion can be defined in the provision of the reference and/or contrary image set such as, for example, only female or only male persons, or only portrait paintings from a specific painter. Likewise, a value range may be defined which relates to a range of the age of the depicted persons such as, for example, only images of persons who were from 30 to 40 years old at the time of the making of a portrait painting. In this way, differences between the portrait paintings can be attributed to the depicted, different persons in the best way possible and do not only depend on different painting styles or, e.g., on the gender or age of the depicted persons or the like.

All portrait paintings of the reference and the contrary image set are further selected so that they are also similar to the portrait painting of the image to be examined with regard to the selection criteria mentioned above. Assumptions relating to the identity of the person to be verified may also influence the selection of the portrait paintings of the reference or the contrary image set.

The provision of all images or the two described image sets and of the image to be examined may take place by import through an interface and/or by retrieval from a data base. For carrying out the method, the images may particularly be stored in a memory means such as, for example, in a memory means implemented as a ROM or a RAM, or a memory means comprising a ROM or a RAM. This will be described in more detail in the following. Also feasible is that the images are provided for in different ways, i.e., that, for example, one image is provided for by import via an interface, and another image by retrieval from a data base.

An image-specific feature may represent one or a plurality of features of an image which can be objectively and technically analyzed. For example, such a feature may be a geometric feature relating to a human face such as, for example, the distance, the shape, or the arrangement of the eyes, the nose, and/or the mouth of a person. Moreover, it may also be a feature relating to an artistic aspect relating to a used painting style or a used painting technique. For example, the thickness of a brushstroke in the image may influence the identification an image-specific feature. The thickness of such a brushstroke or, for example, the distance between the eyes of a person may particularly be quantified based on a number of pixels or the distance of pixels to each other or the like in an image. However, an image-specific feature may also be a feature which is not directly identifiable in the image. Particularly, the method of machine learning can be trained to take the described features into consideration in identifying an image-specific feature. This, particularly the training of a neural network, will be explained in more detail in the following.

Here, all images of the reference and the contrary image set are analyzed by the method of machine learning. Likewise, the image to be examined is analyzed by the method of machine learning. For each image, at least one image-specific feature is determined in an automated manner and allocated to the respective image by using the method of machine learning in this way.

Here, the method of machine learning is trained so that the image-specific features are similar for the images depicting the same person. Further, the image-specific features are not similar for the images depicting different persons. Dies is particularly due to the fact that the images depicting the same person are based on similar, particularly person-specific features.

A similarity of features depends on or may be represented by a distance between features, for example, when the identified features were determined as vectors. For example, on the one hand, the vectors for images depicting the same person may be disposed spatially close to each other, i.e., similar to each other, while, on the other hand, the vectors for images depicting different persons may be disposed spatially far apart from each other in the vector space.

In other words, closer similarities will emerge between the features of images depicting the same person, and fainter similarities between features of images depicting different persons. An established similarity between two features is referred to as a similarity value.

Such a similarity value may be determined, for example, from the inverse value of the Euclidean distance between two vectors or features. Here, a faint or low similarity may be equivalent to a small similarity value while a close or high similarity would then be equivalent to a large similarity value. In this way, larger differences result in smaller similarity values which is in line with the explained understanding of a closer and fainter similarity. It is also possible that the similarity value is determined based on a cosine similarity of two vectors or features. Here, the similarity value is determined based on the cosine of the angle between two vectors, the smaller or acute angle among two congruent intersection angles being used as the angle for determining the cosine. The cosine of an angle of zero is one, while the cosine of an angle of pi/2 is zero. Therefore, a small angle results in a large cosine value and thus in a larger similarity value, while a larger angle results in a smaller cosine value and thus in a smaller similarity value. In particular, the similarity value may be equivalent to the cosine.

The determined similarity values are used for determining the first and the other distribution.

Therefore, the first distribution is particularly determined from similarity values resulting from the difference between features of images depicting the same person, i.e., for example, from the difference of a feature of an image of the reference image set to a feature of another image of the reference image set. Moreover, similarity values resulting from the difference between features of images of the contrary image set depicting the same contrary person may also be used. In other words, the first distribution may also be referred to as a first set of values comprising the discussed similarity values.

The other distribution is then particularly determined from similarity values resulting from the difference between features of images depicting different persons, i.e., for example, from the difference of a feature of an image of the reference image set to an image of the contrary image set. It is also possible that similarity values resulting from the difference between features of images of different contrary persons are used. In other words, the second distribution may also be referred to as a second set of values comprising the discussed similarity values.

The first distribution of similarities is also referred to as the correspondence distribution or genuine distribution, and the other distribution of similarities as the non-correspondence distribution or imposter distribution.

If, for example, four similarity values having the values (4, 5, 5, 6) were determined from, particularly paired, comparisons of features of images depicting the same person the first distribution may be the set of values of (4, 5, 5, 6).

If, further, four similarity values having the values (2, 3, 3, 4) were determined from, particularly paired, comparisons of features of images depicting different persons the other distribution may be the set of values of (2, 3, 3, 4).

The parameter for the evaluation of a criterion for distinguishing the reference person from the contrary person(s) is determined depending on the first and/or the other distribution. The determined parameter may particularly be used as a threshold in the evaluation of the criterion.

The parameter is determined from a value range of the similarity values of the first and/or the other distribution. Particularly, the value range may relate to an intersecting set or an overlap range of the first and the other distribution, the parameter being determined, e.g., as a mean value, a minimum value, or a maximum value of this intersecting set/this range. In the example of the first and the other distribution mentioned above, the determined parameter could be established, e.g., as the similarity value of 4. However, if no intersecting set or overlap range exists the parameter may also be determined as the particularly smallest similarity value of the first distribution. It is also feasible that the parameter is determined as the mean value of the first distribution. In analogy to the example mentioned above, the parameter could also be identified as the similarity value of 5. What is important is that the determined parameter renders the evaluation of a criterion possible, the result the evaluation rendering the distinction of the person depicted in an image to be examined from the reference or the contrary person(s) possible.

Particularly, the parameter is determined so that a predetermined false acceptance rate, e.g., a false acceptance rate of 0.001 is not exceeded, i.e., that no more than a specific percentage of persons to be verified who are actually not identical with the associated reference person is verified as identical with the reference person according to the method. For determining the parameter, for example, pairs of images of the contrary image set not depicting the same person may be used, a similarity value being determined for each pair of images, and the parameter then being selected so that, using the parameter, only a maximum percentage of actually non-matching pairs of images which is smaller than or equal to the predetermined false acceptance rate is identified as matching. The parameter may also be determined so that a preliminary parameter is selected as an initial value for an iteration such as, for example, a value from the intersecting set of the first and the other distribution, and that the parameter is determined by iteration so that the predetermined false acceptance rate is not exceeded.

The criterion may be evaluated, e.g., by comparing the determined parameter to the degree of similarity.

The degree of similarity results from a comparison of the features of the image to be examined with each image of the reference image set. For example, a similarity value may be determined for each pair of images comprising the image to be examined and an image from the reference image set, the degree of similarity then being determined, e.g., as a minimum value, a mean value, or maximum value of the multitude of similarity values. In other words, the determined degree of similarity specifies how similar the person to be verified and the reference person are. In analogy to the example mentioned above, the degree of similarity could be determined as a mean similarity value of 5. However, another way of determining the degree of similarity is also possible.

A correspondence of the person to be verified to the reference persons may result when the determined degree of similarity is larger than the previously determined parameter. In the example selected here, the determined parameter is therefore a threshold of a threshold criterion which, for example, has to be exceeded for the verification based on the degree of similarity. Particularly, the criterion becomes technical in this way since the required parameter for evaluating the criterion is based on features of the images which are objectively and technically determinable.

Referring to the above-mentioned example, the result of the verification would therefore be that the person to be verified corresponds to the reference person since the degree of similarity, here 5, is larger than the determined parameter or the threshold, here 4, and the criterion is therefore met. If, on the other hand, the degree of similarity does not meet the criterion, for example, because the degree of similarity was determined as a mean similarity value of 3, the result of the verification would be that the person to be verified is not identical to the reference person.

With the method described here, a verification of persons in portrait paintings is rendered possible which is based on objective and technically determinable properties of portrait paintings and which is particularly not exclusively attributable to the error-prone opinion of a human being. With the described automated feature allocation regarding the images of a reference person and the images of one or a plurality of contrary persons, as well as with the distributions resulting therefrom, advantageously, a high reliability as well as a high accuracy can be achieved in the verification of persons which can particularly also be carried out quickly and at low cost.

In another embodiment, the provision of the images is implemented by import through an interface or from a data base and/or by recording the portrait painting by using an imaging system.

The import refers to the transmission of the previously described images from one electronic system to another electronic system such as, for example, from a server to a system designed for the verification of persons according to an embodiment described in this disclosure. Such a system may be or comprise, for example, a mobile telephone or a computer. A server may be foreign to the system and constitute or comprise a data base, images, particularly image files of various portrait paintings being stored in the data base and, for at least part the images, the person depicted therein being previously known, and the associated identity information being allocated to the image. Further, of course, information relating to a painter/paintress, an epoch, a painting style, etc., or a gender or age of the depicted person may also be allocated to an image. The provision of the images may then be implemented by a transmission of the images and the information allocated to the images from the data base to a memory of the system. Particularly, the images may be saved or cached in a memory of the system until the method for the verification of persons is completed.

Importing the images via an interface is also possible. The interface renders a data-technical transmission between two electronic systems like, for example, between a memory means foreign to the system and the system mentioned above possible.

Particularly, the import or transmission of the images through the interface and/or from the data base can be rendered possible with the aid of various connectivity standards such as, for example, USB, Bluetooth, WLAN, Wi-Fi, etc.

The images or part of the images may also be provided for by recording a portrait painting by using an imaging system. Such an imaging system may particularly be part of the system for the verification of persons such as, for example, the camera of a mobile telephone. The imaging system may comprise one or a plurality of image sensors such as, for example, CCD or CMOS sensors. An image sensor captures one or a plurality of images of a portrait painting owing to light beams impinging on the image sensor from the portrait painting or part of the portrait painting. An image of a portrait painting generated in this way is encoded in the form a previously described image file.

With the described ways of providing for the images, it is ensured that the images and information required for carrying out the method can be reliably made available to a system for the verification of persons. Such a system will be described in more detail in the following.

In another embodiment, the image-specific features are determined as vectors in a vector space, the first and/or the other distribution and/or the degree of similarity being determined based on established differences between the vectors.

In case of a feature established as a vector, the features of an image discussed at the outset are represented by entries in the vector. Here, these entries may be numeric values. An entry may be a component or an element of a vector, the number of the components/elements of a vector determining the dimension of the vector space. The vector space may therefore be a multi-dimensional mathematical space, all established features being located in the same vector space.

The differences between the vectors may be, for example, differences between vectors. Such a difference may be the Euclidean distance between two vectors. How the first or the other distribution and/or the degree of similarity can be determined from the differences between the vectors or from the magnitude-related differences of the vectors was already described above.

A technical analysis of an image by using the method of machine learning is advantageous in that a feature established as a vector is not directly indicative of a property or properties of an image such as, for example, a distance between the eyes but that, owing to the method of machine learning, the vector can represent such a property or others in a abstracted or abstract form. This type of representation of properties of an image in a vector results in an objective comparability of different images by a comparison of vectors or features.

When the image-specific features are established as vectors in a vector space, this advantageously results in a simple and objective comparison of the properties of different images. The objectivity of the comparison particularly results from the normalization of the vectors.

In another embodiment, a value from a value range of the first and/or the other distribution is determined as a parameter for evaluating the criterion.

If the parameter for the evaluation is a, particularly numeric, value from a value range of the first and/or the other distribution the criterion such as, for example, the threshold-criterion mentioned at the outset can be quickly and reliably evaluated.

Such a value may therefore be a threshold from which a correspondence of the person depicted in the images compared to each other can be assumed such as, for example, the mean value of the similarity values in an overlap range of the first and the other distribution. The degree of similarity to be established for the verification of persons may then also be determined as a value from the value range of the similarity values of the first and/or the other similarity distribution so that a simple and rapid evaluation of the criterion is rendered possible.

In another embodiment, a first probability distribution is generated from the first distribution, and another probability distribution is generated from the other distribution.

In the comparison of features of images of the same person, for example, the reference person, it may occur that a similarity value or similarity values from predetermined similarity value ranges is/are repeatedly determined, for example, because the underlying geometric features such as the distance between the eyes in the images of the reference person and therefore the images are alike. For example, a corresponding prevalence of a similarity value may emerge in the determination of similarity values. In comparisons of features of images of different persons, for example, the reference person and the contrary person, it may also occur that a similarity value is repeatedly identified. This may particularly be the case when the same differences between the features of the images of the reference and the contrary person like, for example, differences in the established distance between the eyes are present. In this way, similarity values of the first and the other distribution may accumulate, particularly, a histogram of the prevalences can be derived for the first and the other distribution.

The reference and/or the contrary image set comprise images of a multitude of different portrait paintings, for example, images of 10 to 100 different portrait paintings, respectively, so that also a correspondingly high number of features results from a corresponding number of images. Here, it may particularly occur that associated similarity values of the first and the other distribution accumulate so that a substantially normally distributed histogram for the first and/or the other distribution results from the prevalences of the established similarity values. However, it is also possible that the histogram exhibits no normal distribution or its properties.

From a histogram, a probability distribution can be generated. Alternatively, a particularly continuous probability distribution can be generated from the similarity values by a so-called core density estimation method. These are generally not normally distributed.

Since the first distribution is determined from comparisons of the features of images showing the same person the first probability distribution allocates a probability of a correspondence of the compared features to a respective similarity value. A correspondence of the compared features indicates that the images show the same person with regard to these compared features.

Since the other distribution is established from comparisons of the features of images showing different persons the other probability distribution allocates a resulting probability of a non-correspondence of the compared features to a specific similarity value. A non-correspondence of the compared features indicates that the images show different persons with regard to these compared features.

Referring to the example mentioned at the outset, the highest probability (prevalence) of a correspondence of the compared features could be a similarity value of 5 in case of a normally distributed probability distribution, for example, because a similarity value of 5 corresponds to the expected value of the first probability distribution. The highest probability (prevalence) of a non-correspondence of the compared features could, accordingly, be a similarity value of 3. To the remaining similarity values of the first and the other probability distribution, then, correspondingly lower probabilities of a correspondence or non-correspondence may be allocated, respectively.

If a similarity value of 5 was established by a comparison of two features a probability of, for example, 80% for a correspondence can be allocated to the similarity value of 5 depending on the first and the other probability distribution. Further, due to an overlap of the first and the other probability distribution, for example, a probability of 20% for a non-correspondence may be allocated to the similarity value of 5. To a similarity value of 3, for example, a probability of 60% for a non-correspondence and a probability of 40% for a correspondence may be allocated depending on the first and the other probability distribution.

By generating a first and another probability distribution, the verification may advantageously be supplemented by stochastic analysis methods known to the person skilled in the art. Furthermore, the first and the other probability distribution also render the indication of a probability of the correctness of the result of the verification possible. This will be explained in more detail in the following.

In another embodiment, at least one plausibility value is determined in the establishment of the degree of similarity, the plausibility value being determined as a ratio between the probabilities in the first and the other probability distribution allocated to a (similarity) value.

The plausibility value may then be the quotient of the probability of a correspondence and the probability of a non-correspondence of the features, the probability of a correspondence arising from the first probability distribution, and the probability of a non-correspondence from the other probability distribution. Therefore, a plausibility value can be allocated to each similarity value. The plausibility value relativizes the two probabilities allocated to a similarity value. For determining the degree of similarity, a plausibility value may then be determined for each established similarity value.

If the probabilities for a first similarity value of 5 were allocated with 80% for a correspondence and 20% for a non-correspondence like in the previous example, this results in the first plausibility value of, e.g., 8/2. If the probabilities for a second similarity value of 3 were allocated with 40% for a correspondence and 60% for a non-correspondence, this results in the second plausibility value of 2/3. Of course, the inverse values of the quotients just described may also be used as plausibility values.

For determining the degree of similarity, then, all plausibility values which are determined for each similarity value which is determined in the comparison of the image to be examined with each image of the reference image set as previously explained may be multiplied by each other, or their mean value may be formed. This product or the mean value forms an overall plausibility value. Then, the degree of similarity may be established as the similarity value to which the overall plausibility value is allocated, particularly depending on the previously discussed allocation of plausibility values to similarity values.

In this way, the degree of similarity can be determined with increased accuracy and reliability since, by the described relativization of the probability values, a weighting takes place in the determination von similarity values, and outliers have less of an influence on the degree of similarity.

In another embodiment, a reliability value is determined, this parameter indicating a probability of the correctness of the result. Particularly when the person to be verified was identified as the reference person (i.e. when the degree of similarity meets the criterion) the reliability value can indicate the probability of the person identified as the reference person actually not corresponding to the reference person and therefore corresponding to a false acceptance rate (false match rate). When the person to be verified was identified as a person not corresponding to the reference person (i.e., when the degree of similarity does not meet the criterion), the reliability value may indicate the probability of the person not identified as reference person in fact actually corresponding to the reference person and therefore corresponding to a false non-acceptance rate (false non-match rate).

To this end, the threshold-specific false acceptance rate and the threshold-specific false non-acceptance rate can be determined from the established probability distributions for each threshold (similarity threshold), a representation of this interrelation being feasible, e.g., in the form of a ROC curve (receiver-operating characteristic curve). This interrelation may then be evaluated for determining the reliability value. The generation of a receiver operating characteristic curve is known to the person skilled in the art here. As previously explained, the parameter for evaluating the criterion may also be determined depending on this interrelation, particularly as the threshold in case of which the false acceptance rate is smaller than or equal to a predetermined threshold, e.g. 0.001.

It is further conceivable that the reliability value as well as the result of the verification are output via an output means, particularly to a user of a system for the verification of persons. In this way, it can be conveyed to the user how correct the result determined by the proposed method is.

Particularly, the reliability value may also be compared to a predetermined threshold, a reliability value smaller than the threshold indicating a particularly reliable correctness of the result.

With the determination of a reliability value, the result of the verification is advantageously quantified by a probability. In this way, the similarity between a person to be verified and the reference person can be quickly and objectively evaluated.

In another embodiment, the method of machine learning is trained as follows:
providing for a first training image set including portrait photographs, i.e., photographs of faces, at least one photograph-specific basic truth being allocated to each image,
pre-training a neural network using the first training image set,
providing for another training image set including images from portrait paintings, at least one painting-specific basic truth being allocated to each image,
specializing the pre-trained neural network using the other training image set,
the method of machine learning trained in this way being designed to determine image-specific features for images of portrait paintings.

An untrained method of machine learning has to learn to identify at least one image-specific feature in a quality enabling an execution of the person verification method described at the outset with a sufficient accuracy for an image of a portrait painting. To this end, a neural network not yet trained can be adapted by training with a first and another training image set. A neural network may comprise a plurality of levels, a multitude of neurons being potentially arranged in each level, the arrangement as well as links between the different levels being adaptable by the training. A neural network suitable for this purpose may be, for example, a residual neural network.

For the training, a first training image set including portrait photographs constituting the images of the first training image set is provided for. If the portrait photographs are available as digital image files, the images can be provided by or in the form of these image files. Of course, it is also possible to generate the images of the first training image set by a reproduction of portrait photographs, e.g. by using an imaging system. This first training image set comprises a sufficiently high number of images such as, for example, 10,000 or more images, particularly up to 1,000,000 images. The images of the first training image set are photographs of persons or faces, particularly portrait photographs. The first training image set comprises both images of male persons and female persons. The images also depict persons of different phenotypes, i.e. particularly persons having different visual appearances. At least two images of each person are included, the at least two images depicting the person from different angles of view. Here, at least one photograph-specific basic truth is allocated to each image. Particularly, the basic truth corresponds to the identity of a person depicted in an image. The high number of images of photographs may be quickly and cost-effectively provided, for example, by retrieval from a data base. In a portrait photography and in a portrait painting, at least the complete face of a person is depicted.

It is also conceivable that at least part of the images of the first training image set is generated by changing features of images which are already part of the first training image set, for example, by method of image processing known to the person skilled in the art. Such a modification may take place, e.g., by changing the orientation, or mirroring, or by changing a contrast intensity of an image. Alternatively or cumulatively, it is conceivable that at least part of the images or all images of the first training image set is/are provided by changing features of portrait photographs so that these simulate images of portrait paintings. For example, portrait photographs or images of portrait photographs can be changed by methods of image processing known to the person skilled in the art so that these images replicate portrait paintings in their appearance, i.e., that the images simulate portrait paintings. This may be referred to as a data augmentation of the first training image set.

The neural network is then pre-trained by the images of the first training image set being analyzed by using the neural network, and the neural network is adapted depending on of the result of the analysis, i.e., particularly depending on at least one image-specific feature identified by the neural network. Such an adaptation of the neural network may particularly be realized by an iterative approach to an optimization criterion. An analysis of an image by the neural network may, for example, describe that the individual pixels of an image encoded as an image file, particularly their intensity values, are analyzed by using the neural network. In this way, the neural network can detect edge shapes, curve shapes, and/or color graduations in an image, particularly from the differences, particularly of intensities, between pixels. Here, at least one image is an input variable, and at least one feature identified by the analysis an output variable of the neural network.

For adapting the neural network, a first sub-set of, for example, three images (e.g., image A, image B and image C) of the first training image set is analyzed in a first cycle of the training, the identity of the same person being allocated to two images A, B as the basic truth, i.e., two of the images A, B depicting the same person. To the remaining image C, the identity of another person is allocated as the basic truth so that this image C therefore depicts a person other than the images A and B. After the analysis of the three images, the neural network has generated three image-specific features/feature vectors which, after the first cycle of the training, usually do not exhibit a high quality with regard to potential conclusions relating to the depicted persons or the basic truths. An adaptation/training of the neural network may now be carried out so that feature-dependent evaluation parameters are minimized or maximized or reduced to the extent that the evaluation parameter is equal to a predetermined threshold or smaller than this predetermined threshold, or increased to the extent that the evaluation parameter is equal to a (another) predetermined threshold or larger than this (other) predetermined threshold. In other words, an evaluation parameter-dependent cost function may be minimized or maximized by the training, particularly to a predetermined degree. An evaluation parameter may be a difference between two features/feature vectors determined by the analysis. A threshold may be, for example, a predetermined difference between the two features/feature vectors for the images depicting the same person, the evaluation parameter being minimized or minimized to the extent that it is smaller than the predetermined difference by using iterative adaptations, i.e., training of the neural network. Another threshold may be a predetermined other difference between the two features/feature vectors determined for the images depicting different persons. The evaluation parameter may be maximized or maximized to the extent that it is larger than the predetermined other difference by using the iterative adaptations of the neural network. This procedure can be referred to as an approximation to an optimization criterion.

In further cycles, the described procedure is also carried out for other sub-sets of the first training image set which are different from the first sub-set and from each other so that the neural network is optimized for identifying features of images particularly of different persons. For the explained training, particularly as a cost function, for example, a triplet loss function may be used. Here, the use of such a function is known to the person skilled in the art.

A partial quantity of the first training image set may also not be used for the training, but the images of the partial quantity may be held back for the assessment of a quality of the neural network. For assessing the quality of the pre-trained neural network, for example, the images held back are analyzed by the pre-trained neural network without the photograph-specific basic truth after the pre-training, and the basic truths allocated to the images are used to revise whether the features determined in this way allow for drawing conclusions on the persons depicted in the images, or established features for images of the same person do not deviate from each other to more than a predetermined degree and/or established features for images of different persons deviate from each other to more than a predetermined degree. For drawing conclusions on the persons depicted in the images, for example, a difference between the features of such pairs of images not depicting the same person may be determined. Here, the identities of the depicted persons are known from the allocated to basic truths. Moreover, the quality may be sufficient when it is determined, with the aid of the determined difference, that the predetermined degree is exceeded. As the predetermined degree, for example a minimum value of the difference between two features of images not depicting the same person may be defined.

For specializing the pre-trained neural network for the analysis of images of portrait paintings, another training image set is provided. Such a specialization of a pre-trained neural network is also referred to as transfer learning. The other training image set comprises images of different portrait paintings, 300 or more images, at least one painting-specific basic truth being allocated to each image. Such a painting-specific basic truth may particularly relate to or be the identity a depicted person. The pre-training of the neural network allows for the other training image set to comprise a smaller number of images than the first training image set. This is particularly advantageous since images of portrait paintings are typically not available in numbers as high as photographs. The first and the other training image set comprise at least two images per identity, i.e., at least two images of the same person.

It is also feasible that at least part of the images or all images the other training image set are provided by features of portrait photographs, particularly of portrait photographs of the first training image set or portrait photographs which are not part of the first training image set being modified so that they simulate images of portrait paintings. For example, portrait photographs or images of portrait photographs may be modified by methods of image processing known to the person skilled in the art so that these images replicate portrait paintings in their appearance, i.e. simulate the images of portrait paintings. However, other features of the images may also be modified such as, for example, a contrast intensity, or an orientation of the images. This procedure may also be referred to as data augmentation. In this way, particularly the number of images of the first and the other training image set can be increased in an easy manner.

For specializing the pre-trained neural network, analogous to the described procedure of the pre-training, the pre-trained neural network is then adapted/trained by using the other training image set so that features do not deviate from each other to more than a predetermined degree for images of portrait paintings of the same person and/or deviate from each other to more than a predetermined degree for images of portrait paintings of different persons. Particularly, the further training of the neural network may therefore now be carried out so that feature-dependent evaluation parameters are minimized or maximized or reduced to the extent that the evaluation parameter is equal to a predetermined threshold or is smaller than this predetermined threshold, or increased to the extent that the evaluation parameter is equal to a (another) predetermined threshold or is larger than this (other) predetermined threshold. In other words, an evaluation parameter-dependent cost function can be minimized or maximized by the training, particularly to a predetermined extent. This approach may also be referred to as an approximation to an optimization criterion.

Of course, it is also feasible that a partial quantity of the other training image set, for example, 30 images of the 300 images are not used in the specialization of the pre-trained network, and that these images are then, analogous to the abovementioned procedure, used for the assessment of the quality of the specialized neural network.

With the described training of the method of machine learning, it is advantageously achieved that features suitable for the reliable verification can also be determined for images of portrait paintings to which no basic truth is allocated. Particularly, the trained method of machine learning uses the specialized neural network.

Of course, it is also feasible that the method of machine learning is only trained using the first training image set. To this end—as previously explained—a first training image set including portrait photographs may be provided, at least one photograph-specific basic truth being allocated to each image. Further, as likewise previously discussed, a training of a neural network using the first training image set is carried out, the method of machine learning trained in this way being designed to identify image-specific features for images of portrait paintings. Particularly, therefore, no specialization of the pre-trained neural network using another training image set will take place. In this case, the first training image set may comprise portrait photographs and/or portrait paintings and/or images of portrait paintings simulated according to the preceding explanations. Particularly, it is conceivable that the first training image set exclusively comprises simulated portrait paintings, or exclusively images of portrait paintings, or exclusively simulated portrait paintings and images of portrait paintings in this case.

As discussed, at least one image-specific feature can be determined for an image of a portrait painting by using the trained method of machine learning. As described above, such an image-specific feature may then be used for a method for the verification of persons in portrait paintings.

In other words, the training of the method of machine learning described here ensures that the verification of persons in portrait paintings is rendered possible in a sufficient quality or accuracy and reliability.

As mentioned at the outset, the trained neural network may comprise a plurality of, particularly serially connected, levels, intermediate results becoming more abstract with progressing levels during the analysis of an image. The result of the analysis or the output variable is then at least one image-specific feature. Due to the described abstraction during the analysis of an image, the features determined in this way may also relate to features of a depicted face which remain hidden to the subjective human sight. In this way, advantageously, more differentiated features increasing a reliability and accuracy in the verification of persons in portrait paintings emerge as compared to an analysis of an image by a human.

Further proposed is a system for the verification of persons which comprises an imaging system and/or an interface, a memory means, a data processing means, as well as an output means, the system being designed or configured to carry out a method according to one of the previously disclosed embodiments.

The system is implemented as a portable end device, e.g., as a mobile telephone, or is provided for by the end device or the elements of the end device. The implementations of an associated imaging system, interface, or memory means were discussed previously. The data processing means may be implemented as or comprise an integrated circuit on a microchip. The data processing means may also be or comprise a microcontroller.

Particularly, the data processing means is designed to analyze images of portrait paintings or image files with the aid of the method of machine learning and to carry out the claimed person verification method according to an embodiment described in this disclosure. An output means may be implemented, for example, as a display and used for outputting particularly a result or a reliability value of the verification of persons to a user.

Further, a computer program product including a computer program is proposed, the computer program comprising software means for executing one, a plurality of, or all steps of the method for the verification of persons in portrait paintings according to one of the embodiments described in this disclosure when the computer program is executed by or in a computer or an automation system.

Further, a program is described which, when running on a computer or in an automation system, causes the computer or the automation system to execute one, or a plurality of, or all steps of the method for the verification of persons in portrait paintings according to one of the embodiments described in this disclosure, and/or a program storage medium on which the program is stored (particularly in a non-transitory form), and/or a computer which comprises the program storage medium, and/or a (physically, e.g., electrically, e.g., technically generated) signal wave, e.g., a digital signal wave carrying the information representing the program, e.g., the abovementioned program which comprises, e.g., encoding means capable of executing one or all of the process steps described herein.

This means that the method according to the invention is, for example, a computer-implemented method. For example, all steps or only some of the steps (i.e., less than the total number of steps) of the method according to the invention may be executed by a computer. An embodiment of the computer-implemented method is a use of the computer for performing a data processing method. The computer comprises, for example, at least one microcontroller or processor, and, for example, at least one memory to (technically) process the data, for example, electronically and/or optically. The processor is comprised of, for example, a substance or compound which is a semiconductor, for example, at least partly, an n- and/or p-doped semiconductor, for example at least one II-, III-, IV-, V-, Vl-semiconductor material, for example (doped) silicon and/or gallium arsenide. The described steps, particularly the determination steps and the verification step are executed, for example, by a computer. Determination steps or calculation steps are, for example, steps for determining data in the scope of the technical method, for example, in the scope of a program. A computer is, e.g., any type of data processing device, e.g., an electronic data processing device. A computer may be a device which is commonly regarded as such, e.g., desktop PCs, notebooks, netbooks, etc., but may also be any programmable device such as, e.g., a mobile telephone or an embedded processor. A computer may be comprised of, for example, a system (network) of “sub-computers”, each sub-computer constituting an independent computer. Steps executed or performed by a computer or an automation system may particularly be the determination steps and/or the verification step.

The computer program product advantageously enables performing a method for the verification of persons in portrait paintings according to one of the embodiments described in this disclosure for which technical advantages were previously described.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The invention is explained in more detail based on embodiments.

FIG. 1 shows a reference image set, a contrary image set, and an image to be examined.

FIG. 2 shows a flow chart of an embodiment of a method for the verification of persons in portrait paintings according to the invention.

FIG. 3 shows a flow chart for the training of a method of machine learning.

FIG. 4 shows an embodiment of a system for the verification of persons in a portrait painting according to the invention.

FIG. 5 shows a first and another distribution.

In the drawings, reference numbers may be reused to identify similar and/or identical elements.

### DETAILED DESCRIPTION

In the following, identical reference numerals designate elements having the same or similar technical features.

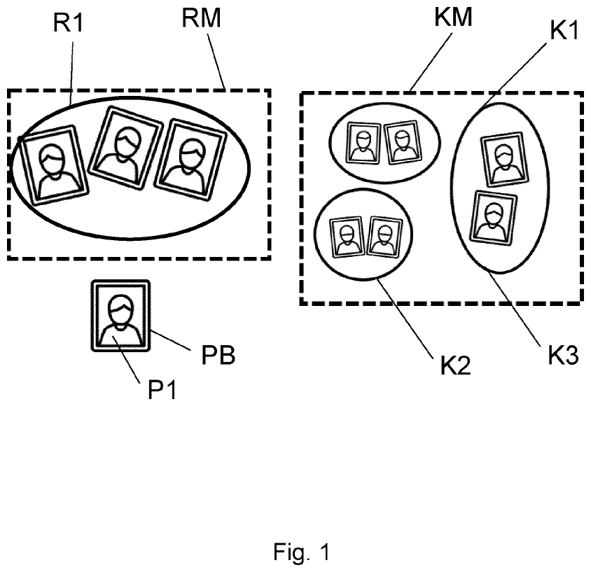

FIG. 1 shows the reference image set RM including three different images of the reference person R1. Here, the images may depict portrait paintings of the reference person R1 which were made by different painters and/or at different times in the life of the reference person R1. What is important is that, for all images of the reference image set RM, it is previously known that they depict the reference person R1.

Furthermore, the contrary image set KM is shown in FIG. 1. The contrary image set KM comprises altogether six images, two images reproducing different portrait paintings of a first contrary person K1, two images reproducing different portrait paintings of a second contrary person K2, and two images reproducing different portrait paintings of a third contrary person K3. Each image of the contrary image set KM reproduces a portrait painting of a historically relevant person K1, K2, K3 the identity of whom is also previously known. The contrary persons K1, K2, K3 are different from each other, i.e., they relate to different persons. In addition, all contrary persons K1, K2, K3 are different from the reference person R1.

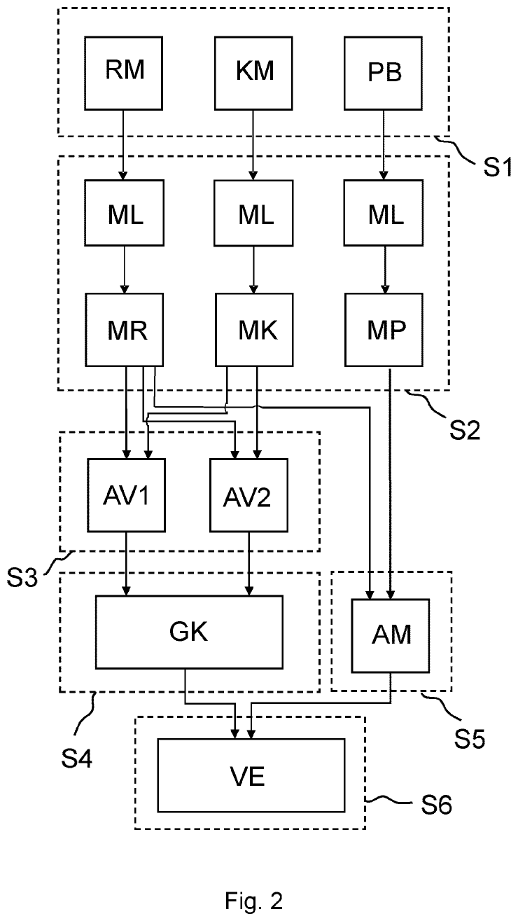

Further, an image PB to be examined of a portrait painting of a person P1 to be verified is shown in FIG. 1. Here, the images of the reference image set RM were selected so that it can be verified, by using the person verification method (see FIG. 2), whether the person P1 shown in the image PB to be examined corresponds to the reference person R1.

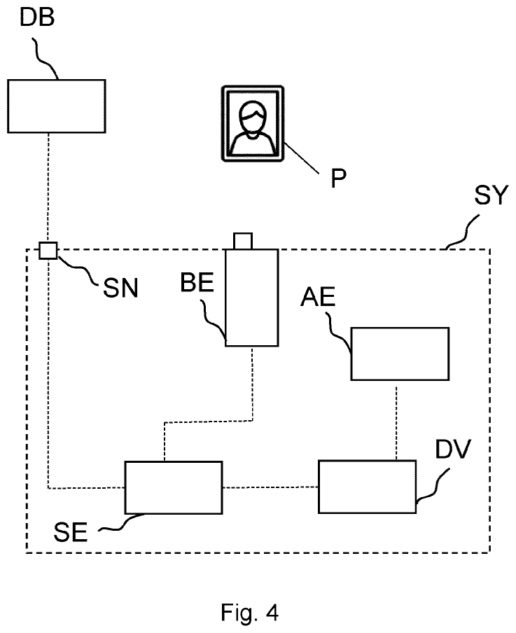

In FIG. 2, a schematic flow chart of a method for the verification of persons in portrait paintings according to the invention is shown. The method comprises six steps S1 to S6 which will be explained in the following. In step S1, the images shown in FIG. 1 are provided. Here, the reference image set RM as well as the contrary image set KM may be provided by retrieving images encoded as image files from a data base DB (see FIG. 4). The image PB to be examined can be provided by capturing a portrait painting P by using an imaging system BE (see FIG. 4). It is also feasible that the image to be examined is also retrieved from the data base DB. The images provided in this way may be cached in a memory means SE (see FIG. 4).

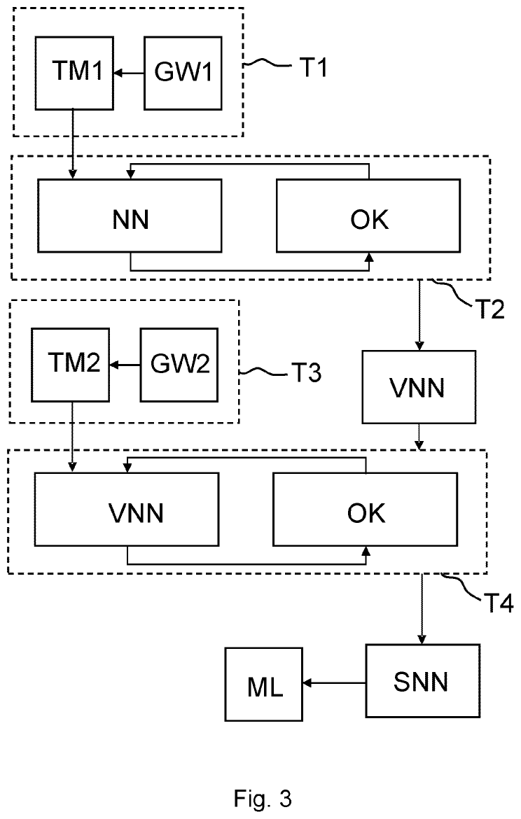

In step S2, the images of the reference image set RM are supplied to a method of machine learning ML as an input variable by using a data processing means DV (see FIG. 4), the data processing means DV carrying out this method. In the method of machine learning ML, the images are analyzed with the aid of a specialized neural network SNN (see FIG. 3) so that, for each image, at least one image-specific feature is determined and allocated to the respective image as an output variable of the method of machine learning. In this way, a multitude of image-specific features MR is obtained for the images of the reference image set RM. For the images of the contrary image set KM as well as for the image PB to be examined, the procedure is analogous so that, for the images of the contrary image set KM, a multitude of image-specific features MK is obtained, and, for the image PB to be examined, at least one feature MP is obtained. The features may be determined as vectors and located in a vector space.

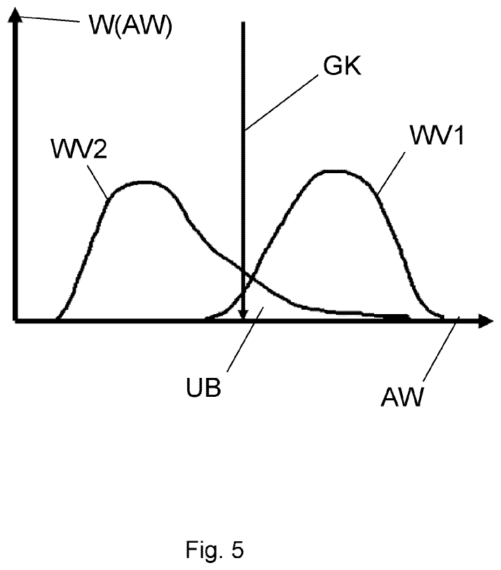

From the image-specific features MR allocated to the images of the reference image set RM and the features MK allocated to the images of the contrary image set, similarity values AW for determining a first distribution are determined by comparison of the features of images of each pair of images the images of which depict the same person in step S3. By comparing the features of images of each pair of images the images of which depict different persons, similarity values for determining another distribution are determined. A similarity value AW is particularly determined from the difference between two features or from the Euclidean distance between two vectors. In this case, a decreasing difference represents an increasing similarity. The probability distributions WV1, WV2 generated from the first and the other distribution, e.g., by using a core density estimator are schematically shown in FIG. 5.

For each determined similarity value AW of the first or the other distribution, the first and the other probability distribution WV1, WV2 indicate which probability W of a correspondence or non-correspondence is allocated to this similarity value AW (see FIG. 5).

In step S4, a parameter GK for the evaluation of a criterion is determined. The parameter GK is determined as a mean value of the similarity values AW in the value range of an overlap range UB of the first and the other similarity distribution (see FIG. 5). The parameter GK is therefore also a similarity value. As previously explained, the parameter GK may also be determined as a similarity value AW for which a predetermined false acceptance rate is not exceeded.

In step S5, a degree of similarity AM is determined from a comparison between the features MR allocated to the images of the reference image set RM and the feature/the features MP allocated to the image PB to be examined. In this way, a similarity value AW is determined, respectively, by a comparison of the feature(s) MP specific to the image to be examined with the reference image-specific feature(s) of each reference image RB. The degree of similarity AM may then be determined as a mean value of the similarity values AW determined in this way. It is also feasible that, for each established similarity value AW, a plausibility value is determined, and that the degree of similarity AM is then determined as the similarity value AW of the first or the other distribution to which the product or the mean value of the determined plausibility values is allocated as the plausibility value.

In a step S6, the degree of similarity AM is then compared with the parameter GK for evaluating the criterion. The criterion for the distinction may then be used for verifying the person P1, the person P1 to be verified being verified as the person identical to the reference person R1 when the determined degree of similarity AM exceeds a threshold corresponding to the parameter GK. If the degree of similarity is smaller than or equal to the parameter the person P1 to be verified is verified as a person not identical to the reference person R1.

A result of the verification VE established in this way may then be output via an output means AE (see FIG. 4).

FIG. 3 shows a flow chart of the training of a method of machine learning ML. In a training step T1, a first training image set TM1 is provided. In the illustrated embodiment, the first training data set TM1 comprises 10,000 to 1,000,000 portrait photographs, i.e., photographs of persons or their faces. The identities of the depicted persons are allocated to the respective images as a photograph-specific basic truth GW1, i.e., the identity of the depicted persons is previously known. Two images of each person are included in the first training data set TM1.

In a training step T2, a neural network NN is pre-trained by using the first training image set TM1. To this end, two images of the same person and one image of another person are analyzed by the neural network NN in a first cycle. Here, each image is an input variable, and an image-specific feature set determined by the analysis is an output variable of the neural network NN, the feature set potentially comprising or encoding exactly one or more than one feature. For the feature sets determined in this way, a first difference between the two feature sets of images which are to represent the same person is determined, and another difference is determined for the feature sets of images which are to represent different persons. The neural network NN may then be adapted in an optimization OK so that the first difference is minimized and/or the other difference is maximized. Which person is depicted in which image is known in this optimization due to the basic truth GW1. In the optimization OK, the neural network NN may particularly be adapted by an adaptation of the arrangement of the neurons in a level of the neural network NN or by an adaptation of a connection between the levels of the neural network NN. For implementing the optimization OK, a triplet loss function may be used. The remaining images of the first training image set TM1 may be used for the further optimization OK of the neural network NN. When a corresponding quality of the feature determination by the neural network NN is reached, for example, because features for images of portrait paintings of the same person do not deviate from each other to more than a predetermined degree and/or features for images of portrait paintings of different persons deviate from each other to more than a predetermined degree, the pre-training of the neural network NN is completed.

Further, another training image set TM2 is provided in a training step T3. The other training image set TM2 comprises, for example, 300 images of portrait paintings. To each image, at least one painting-specific basic truth GW2 is allocated which particularly allocates the identity of a depicted person to an image.

The provision of the two training image sets TM1, TM2 may take place via a data base as already explained for the other image sets.

The pre-trained neural network VNN is then specialized for the identification of features in images of portrait paintings by using the other training image set TM2 in a training step T4. Particularly, the pre-trained neural network VNN is trained by the specialization so that differences in images which are attributable, for example, to a painting style are taken into consideration in the identification of image-specific features. The result of such a training is a specialized neural network SNN which can be used in a method of machine learning ML. The method of machine learning ML is then designed to determine image-specific features MR, MK, MP for images of portrait paintings so that features for images of portrait paintings of the same person do not deviate from each other to more than a predetermined degree and/or that features for images of portrait paintings of different persons deviate from each other to more than a predetermined degree.

FIG. 4 shows an embodiment of a system SY for the verification of persons in a portrait painting P according to the invention. A data base DB may be stored on a server outside of the system which the system SY can access via an interface SN, for example, by using an Internet connection. As described in FIG. 2, a reference image set RM including images of a reference person R1 as well as a contrary image set KM including images of a plurality of contrary persons K1, K2, K3 are retrieved from the data base and transmitted to a memory means SE of the system SY implemented, e.g., as a RAM via the interface SN and provided thereby. In addition, a portrait painting P is captured by using an imaging system BE. The portrait painting P shows a person P1 to be verified. The image PB of the person P1 generated in this way is also cached in the memory means SE and provided thereby.

The data processing means DV implemented as a microcontroller now serves to carry out the method according to the invention as described in FIG. 2.

An output means AE implemented as a display may particularly output the result VE of a verification of persons relating to the image PB to be examined or the portrait painting P. In this way, quickly and cost-effectively verifying a person P1 depicted in a portrait painting P with respect to a reference person R1 can be advantageously facilitated for a user.

FIG. 5 shows a value range of the similarity values AW established for the first and the other distribution as well as the first and the other probability distribution WV1, WV2 generated therefrom. Here, the first probability distribution WV1 indicates the probability W of a determined similarity value AW indicating a correspondence. The other probability distribution WV2 indicates the probability W of a determined similarity value AW indicating a non-correspondence. It should be noted that the probability distributions WV1, WV2 are particularly determined so that, for all similarity values AW, the probability is larger than zero. Here, the similarity values AW are entered on the abscissa of the shown coordinate system while the probabilities W depending on the similarity values AW are entered on the ordinate. The first and the other probability distribution WV1, WV2 have a range UB in which the probability distributions overlap, a value range of similarity values AW of the first and the other distribution being allocated to the range UB. The mean value of the value range of the similarity values AW in the overlap range UB may be determined as the parameter GK for evaluating the criterion.

### LIST OF REFERENCE NUMERALS

AE Output means
AMDegree of similarity
AW Similarity value
BE Imaging system
DB Data base
DV Data processing means
GK Parameter for the evaluation of a criterion
GW1 Photograph-specific basic truth
GW2 Painting-specific basic truth
KM Contrary image set
K1 Images of a first contrary person
K2 Images of another contrary person
K3 Images of another contrary person
ML Method of machine learning
MK Features of the images of the contrary image set
MP Features of the image to be examined
MR Features of the images of the reference image set
NN Neural network
OK Optimization criterion
P Portrait painting
PB Image to be examined
P1 Person to be verified
RM Reference image set
R1 Images of the reference person
SE Memory means
SN Interface
SNN Specialized neural network
SY System for the verification of persons
S1 Providing for the images
S2 Identification of the features
S3 Determination of the distributions
S4 Determination of a parameter for the evaluation of a criterion
S5 Determination of a degree of similarity
S6 Output of a verification result
TM1 First training image set
TM2 Other training image set
T1 Provision of the first training image set
T2 Pre-training the neural network
T3 Provision of the other training image set
T4 Specialization of the neural network
UB Overlap range of the first and the other distribution
VE Result of the verification
VNN Pre-trained neural network
W Probability
WV1 First probability distribution
WV2 Other probability distribution

The term non-transitory computer-readable medium does not encompass transitory electrical or electromagnetic signals propagating through a medium (such as on a carrier wave). Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The term “set” generally means a grouping of one or more elements. The elements of a set do not necessarily need to have any characteristics in common or otherwise belong together. The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

1. A method for verification of persons in portrait paintings, the method comprising:
providing a reference image set including images of at least two different portrait paintings, wherein the portrait paintings depict a same reference person;
providing a contrary image set including images of at least two other portrait paintings, wherein the other portrait paintings respectively depict a contrary person;
providing at least one image of a portrait painting to be examined, wherein the portrait painting depicts a person to be verified;
determining image-specific features via a method of machine learning, wherein at least one feature is allocated to each image;
determining a first distribution of similarities by using the features of the images from the reference and/or the contrary image set depicting the same person;
determining another distribution of similarities by using the features of the images from the reference image and/or the contrary image set depicting different persons;
determining at least one parameter required for evaluating a criterion for distinguishing the reference person from the contrary person depending on the first and/or the other distribution of similarities;
determining a degree of similarity by using the features of the image to be examined and each image from the reference image set; and
verifying whether the person to be verified is identical to the reference person when the degree of similarity meets the criterion.

2. The method of claim 1 wherein providing the images takes place by import via an interface or from a data base and/or by recording the portrait painting via an imaging system.

3. The method of claim 1 wherein:
the image-specific features are determined as vectors in a vector space; and
the first and/or the other distribution and/or the degree of similarity is determined based on differences between the vectors.

4. The method of claim 1 wherein a value from a value range of the first and/or the other distribution is determined as the parameter for evaluating the criterion.

5. The method of claim 1 wherein:
a first probability distribution is generated from the first distribution; and
another probability distribution is generated from the other distribution.

6. The method of claim 5 wherein:
determining the degree of similarity includes determining at least one plausibility value; and
the plausibility value is established as a ratio between the probabilities allocated to a similarity value in the first and the other probability distribution.

7. The method of claim 1 wherein:
a reliability value is determined; and
the reliability value indicates a probability of correctness of a result.

8. The method of claim 1 wherein:
the method of machine learning is trained by:
providing a first training image set including portrait photographs, wherein at least one photograph-specific basic truth is allocated to each image;
pre-training a neural network using the first training image set;
providing a second training image set including images of portrait paintings, wherein at least one painting-specific basic truth is allocated to each image; and
specializing the pre-trained neural network using the second training image set; and
the method of machine learning is trained to determine image-specific features for images of portrait paintings.

9. The method of claim 1 wherein the other distribution is determined from a difference between features of images of the reference image set and images of the contrary image set.

10. A method for verification of persons in portrait paintings, the method comprising:
providing a reference image set including images of at least two different portrait paintings, wherein the portrait paintings depict a same reference person;
providing a contrary image set including images of at least two other portrait paintings, wherein the other portrait paintings respectively depict a contrary person;
providing at least one image of a portrait painting to be examined, wherein the portrait painting depicts a person to be verified;
determining image-specific features via a method of machine learning, wherein at least one feature is allocated to each image;
determining a first distribution of similarities by using the features of the images from the reference and/or the contrary image set depicting the same person;
determining another distribution of similarities by using the features of the images from the reference image and/or the contrary image set depicting different persons;
determining at least one parameter required for evaluating a criterion for distinguishing the reference person from the contrary person depending on the first and/or the other distribution of similarities;
determining of a degree of similarity by using the features of the image to be examined and each image from the reference image set; and
verifying whether the person to be verified is identical to the reference person when the degree of similarity meets the criterion, wherein:
a first probability distribution is generated from the first distribution and another probability distribution is generated from the other distribution,
in determining the degree of similarity, at least one plausibility value is determined, and
the plausibility value is established as a ratio between the probabilities allocated to a similarity value in the first and the other probability distribution.

11. A system comprising:
a memory configured to store instructions;
a processing system configured to execute the instructions, wherein the instructions include:
providing a reference image set including images of at least two different portrait paintings, wherein the portrait paintings depict a same reference person;
providing a contrary image set including images of at least two other portrait paintings, wherein the other portrait paintings respectively depict a contrary person;
providing at least one image of a portrait painting to be examined, wherein the portrait painting depicts a person to be verified;
determining image-specific features via a method of machine learning, wherein at least one feature is allocated to each image;
determining a first distribution of similarities by using the features of the images from the reference and/or the contrary image set depicting the same person;
determining another distribution of similarities by using the features of the images from the reference image and/or the contrary image set depicting different persons;
determining at least one parameter required for evaluating a criterion for distinguishing the reference person from the contrary person depending on the first and/or the other distribution of similarities;
determining a degree of similarity by using the features of the image to be examined and each image from the reference image set; and
verifying whether the person to be verified is identical to the reference person when the degree of similarity meets the criterion; and
an imaging interface configured to obtain the at least one image of the portrait painting to be examined.

12. The system of claim 11 further comprising an imaging system configured to record the at least one image of the portrait painting to be examined.

13. A non-transitory computer-readable medium comprising instructions including:
providing a reference image set including images of at least two different portrait paintings, wherein the portrait paintings depict a same reference person;
providing a contrary image set including images of at least two other portrait paintings, wherein the other portrait paintings respectively depict a contrary person;
providing at least one image of a portrait painting to be examined, wherein the portrait painting depicts a person to be verified;
determining image-specific features via a method of machine learning, wherein at least one feature is allocated to each image;
determining a first distribution of similarities by using the features of the images from the reference and/or the contrary image set depicting the same person;
determining another distribution of similarities by using the features of the images from the reference image and/or the contrary image set depicting different persons;
determining at least one parameter required for evaluating a criterion for distinguishing the reference person from the contrary person depending on the first and/or the other distribution of similarities;
determining a degree of similarity by using the features of the image to be examined and each image from the reference image set; and
verifying whether the person to be verified is identical to the reference person when the degree of similarity meets the criterion.
